(19) United States
(12) Patent Application Publication
(10) Pub. No.: US 2004/0148191 A1
(43) Pub. Date: Jul. 29, 2004

(54) Digitized intellectual property archive with preferential method of transfer and routing

(76) Inventor: Clare L. Hoke JR., Upland, CA (US)

Correspondence Address: Clare L. Hoke Jr., Suite 11, 1318 N. Monte Vista Ave., Upland, CA, 91786, US

(21) Appl. No.: 10/729,323

(22) Filed: Dec. 8, 2003

Related U.S. Application Data
(63) Continuation-in-part of application No. 09/621,875, filed on Jul. 21, 2000, now abandoned.

(51) Int. Cl. G06F 17/60

(52) U.S. Cl. 705/1

(57) ABSTRACT

The preferred embodiment of the present invention consists of a physically dispersed and redundant system of computers, regional IPA Servers, networks and Routers; third party IP's, NP's, CP's, DCP's, Servers, Routers, third party Preferred Internet Providers (PIP's), Network Providers (PNP's), Connectivity Providers (PCP's), Digital Content Providers (PDCP's), Servers (PS's), and Routers (PR's), and end user devices connectable to the Internet, hereafter called the Intellectual Property Archive (IPA). The IPA structurally consists of a tiered peer-to-peer network, of distributed authentication, processing, storage and distribution which serves to promote commerce and acts to verify the validity of contractual agreements within digital medias. Said IPA housing, associating, watermarking, embedding, bundling, inspecting, halting, validating and transferring, Transaction Code Identifiers (TCI's), incarcerative Transaction Code Identifiers ({TCI's}) and Intellectual and Copyrighted Properties. Said TCI's comprised of Intellectual Property Identifiers which establish Intellectual Properties as unique and bound to restriction with regard to sale transfer and proliferation within digital medias. Said TCI's further being comprised of generic and generic restrictive digitized information, machine and human readable within the scope of the Present Invention. Said digital Intellectual Property Archive further containing information associated with individual Intellectual Properties in the interest of effecting commerce, and restricting individual information within digital medias. Said Intellectual Property Archive further employing methods of sampling consummated transactions, in the interest of statistically transforming micro-payments, into macro-payments for preferred accounting methods and financial economies of scale. Said Intellectual Property Archive further serving to validate the requirements of contractual agreements employed in commerce within and without of digital domains.

### BACKGROUND OF THE INVENTION

1) Field of the Invention

The present invention represents a method of regulating e-commerce in the interest of protecting property such as information, art, performances and ideas which are copyrighted, licensed, patented, industrial designs, or registered as trademarks. The present invention answers the need for a market based solution regarding the transfer, sale, and proliferation of Intellectual Properties within Digital Media. As novel methods of commerce develop and expand within the digital domain there arises a need to document not only Intellectual Properties themselves, but additional information which serves to distinguish Intellectual Property as novel within digital media. Information which distinguishes Intellectual Property as bound to restrictions with regard to sale, transfer, and proliferation, may be further associated with information intended to promote the legal sale, transfer, and proliferation of individual Intellectual and Copyrighted Properties. The present invention is herein presented in the interest of furthering commerce within digital medias.

(2) Background Art

The world of electronic commerce and information distribution is developing rapidly to meet the needs of consumers, distributors and property holders while attempting at the same time to appear stable and secure. The present invention provides a solution for the owners of property which may be traded in the world wide electronic marketplace. The concern of property owners involves receiving payment for the transfer of said property, when unaccounted for copies of properties are being distributed from individual to individual. As the velocity of computing power increases into the future, the ability to detect and record transactions of property across the electronic medias will be more readily enabled.

Consideration is currently being given to the issue of Trademarks within the Internet Community. “Governing” Internet organizations have recently begun to establish policies and processes for remedies regarding cyber squatters and piracy of Trademarks. Additional Top Level Domains (i.e. .com, org, .net) are currently in preparation, and the effect of adding to, and subdividing the market of generic Top Level Domains (i.e., athletes, sports) is being considered in part as a remedy for Trademark conflicts. Issues regarding the remainder of Intellectual Property within digital medias; Patents, Industrial Designs, and Copyright need to be further addressed however, in the interest of promoting commerce.

Digital Medias represent a largely unregulated arena with regard to the transfer of Intellectual Property. Consumers of Intellectual Property, who purchase such property as music or software, are free to transfer copies of such property adinfinitum to acquaintances via the Internet or other portable digital storage media. Large organizations currently operate profitably exploiting the unregulated transfer of Intellectual Property from individual to individual. When individuals join groups such as Napster, individuals allow files on their computers to become public domain, so that when a would be consumer of Napster desires a particular Intellectual Property, Napster facilitates the transfer of the desired Intellectual Property from the files of individuals registered with Napster. Recently the company, Scour.net, went further in accessing the databases of individuals who were not associated with Scour.net, but who were vulnerable to the intrusion Scour.net's “spiders and bots”.

Current efforts to control the proliferation of Intellectual Property within digital medias includes recognition software, watermarked within an Intellectual Property which identifies a serial number of a portable device that it has been downloaded, so as to prevent its functioning upon a portable device of differing serial identification.

The present author's Pending patent application Ser. No. 09/569388 explores the assessment of digital files, made recognizable to web organizations and individuals as Intellectual Property during the process of transferring such files within digital medias. This approach was premised with the belief that most upstanding organizations would find it to be in their best interest to enter into gainful commerce regarding the transfer and proliferation of Intellectual Properties. However, multiple organizations have found methods of exploiting the proliferation of Intellectual Property without regard to the owners of such property, hence the present invention is presented as a further solution.

The Internet utilizes clearly delineated protocols to perform reliably. For several years the standard for Internet Protocols has been Ipv4. It has been determined that the next generation of digital consumer devices would greatly expand the use of wireless portable computational devices. As such, the next generation of Internet Protocols would have to account for the proliferation of mobile computational and communication requirements. With wireless portable devices in mind, the current recommendation of the Internet Corporation for Assigned Names and Numbers (ICANN) is that Ipv6 be accepted and integrated as the standard Internet protocol. Ipv6 has advantages that it employs 128 bit addresses instead of addresses being 32 bit in Ipv4. Ipv6 also includes powerful routing functionality via simple routing extensions. These routing extensions are designed to enable wireless connectivity via cellular networks, and account for roaming issues as users physically move. These routing functions include:

Internet Provider Selection

Host Mobility (route to current location)

Auto Readdressing (route to new address)

As such, these routing functions provide packet control, including nodal routing; i.e. intermediate locations may be visited on way to a packet's destination. It is herein suggested that a novel application of the features of the Ipv6 protocol may be employed to the benefit of commerce with regard to Intellectual Properties. In the preferred embodiment of the present invention, Intellectual Properties, or Trade Secrets, shall be embedded, prefaced, or associated with preferences for Provider Routing. This shall include digital files not originally intended for Internet applications. By way of example, digital videos, music CD's and software programs which are intended to be sold to end uses, are all capable of being transferred upon the Internet. It is herein suggested that such Intellectual Properties be prefaced, watermarked, or associated with programs (applets, java code, etc.), so that if transferred via the Internet, such Intellectual Properties will be transferred through nodes which have an interest in assuring accountability to Intellectual Property holders.

Such nodes consist of a proprietary network established in deference to Intellectual Property holders, or may consist of Internet Providers and Web Service Organizations who agree to a prescribed level of due diligence with regard to promoting accountability within their domains. In the instance of a proprietary network the recognition of an Intellectual Property will be simplified in that a digital file will have no business entering the domain if it does not contain an Intellectual Property, hence the routing to the proprietary network. However, regardless of the nature of the Provider that Intellectual Properties are preferentially routed to, methods of identifying an Intellectual Property may include Intellectual Property Identifiers as described in the present author's Pending patent Ser. No. 09/569388, scanning of digital files within a Providers domain against reference libraries of Intellectual Properties as delineated by the present author's Pending patent Ser. No. 09/610024, or via routing protocols as associated with Intellectual Properties. Further programs, embedded insignia, watermarks and the like may also serve to distinguish Intellectual Properties, however, upon recognition by a responsible Internet Provider or Web Server, the further routing of said Intellectual Property transmission may be gated until said responsible Internet Provider or Web Server is satisfied that the conditions of lawful transference, sale, or proliferation of said Intellectual Property are met.

It is herein suggested that in the preferred embodiment of the present invention Intellectual Properties will themselves, promote specific paths of transfer of Intellectual Property upon the Internet, and further, that the routes taken by digital bundles will serve to identify said digital bundles as Intellectual Property.

It is herein further suggested that in the preferred embodiment of the present invention, Internet Providers and service organizations which promote accountability to the owners of Intellectual Property will receive preference with regard to routing of digital traffic by those who are interested in promoting accountability within digital domains.

The Present Invention is intended to further address information distribution and dissemination. Within the Internet, peer-to-peer distribution has led to the development of overlay networks. Currently, “smart” routers are being tested to assist with information processing, efficient delivery, and information distribution across nodal networks, for stability and efficiency. The theory is being raised that the Internet may someday become the media, i.e.: distribution, storage, and processing. The Present Invention provides for improved information dissemination within several adaptive modules of Internet, media, and connectivity development.

### BREIF SUMMARY OF THE INVENTION

The present invention represents a solution with regards to accountability and dissemination of Intellectual and Copyrighted Properties within digital medias. In its preferred embodiment, the Present Invention delineates methods for improving commerce and information management within the Internet and will prove to have implications in other digital media as well. The specifications of the Present Invention are intended to enable distributed nodal monitoring and verification of content, being transferred within digital medias. The business model included herein is intended to be illustrative, as the present invention will serve to enable expansive variations of commerce models and techniques.

In pending patent application Ser. No. 09/569388, the author of the present invention suggests a first step in facilitating voluntary compliance with the laws of commerce within digital media requires the standardization of an Intellectual Property Identifier (Transaction Code Identifier (TCI)), which shall serve to distinguish Intellectual Properties as novel within digital medias. Pursuant to the present invention the Transaction Code Identifier (TCI) shall not interfere with the function or enjoyment of lawfully downloaded or transferred property.

Quoting co pending application Ser. No. 09/569388 page3 line 6 . . .

“Certain elements must be present for a transaction of property in the form of digital data files to be held accountable in the electronic realm. Such property must be identifiable via. a particular coding to be recognized by Internet Providers, Network Providers and Internet servers worldwide. Such a code could be in the form of a precursor, not unlike the universally recognized “http://” employed in the world wide web, or perhaps by property type, not unlike the .edu, mil, .com, org designations also employed in web addressing. Coding for the promotion of commerce in electronic media is herein referred to as a Transaction Code Identifier. Along with a Transaction Code Identifier further specific descriptors of the type of information contained in the file, the identity of the property owner, and the requirements to be agreed to by the recipient before the file is transferred may be bundled with the actual digital property file to make a Copyw, or bundle which may be transferred as a whole via electronic medias. In the process of making a transaction, further information must be transferred between parties. There must be information on the purchaser, a method of payment and further information to provide security for both the purchaser and the purchasee. Transaction coding may be in the form of imbedded coding, interlaced within the actual product so as to make it difficult to remove the transaction related information. It is herein suggested that Transaction Code Identifiers may be identified by the word or coding “.copyw” as in www.copyw/hitsong.com or www.hitsong/copyw/uspto.gov, but the actual term used is not as significant as its intended function, and the present invention should not be limited by such manner.”

Pending patent application Ser. No. 09/569388 illustrates several business models describing the use of generic and property specific Transaction Code Identifiers (TCI's) associated with, and or attached, and or bundled with an Intellectual Property such as a Copyright, and how such information may be employed to promote commerce in digital media. The preferred embodiment of the invention described in pending application Ser. No. 09/569388 enables Intellectual Property to be transferred from multiple sources, retail, wholesale, and retail defacto distributors which include customers who are enabled by the invention to become distributors, (i.e. peer to peer distribution) based upon information associated with a particular Intellectual Property; while maintaining accountability to the property holder. However, the establishment of TCI's and the association of TCI's with Intellectual and Copyrighted Properties in the interest of commerce is only the first step in establishing accountability within digital domains. For commerce to flourish, further methods of doing business are herein being delineated. The preferred embodiment of the Present Invention incorporates an Intellectual Property Archive (IPA), dedicated to archiving, verifying, referencing, gating, and consummating the transfers of Intellectual Properties and Transaction Code Identifiers within digital media. An Intellectual Property Archive may be comprised of commercial, academic, non-profit, governmental, corporate, and private concerns.

Property Specific TCI's contain the legal requirements of sale, transfer, ownership and proliferation of individual digitized Intellectual and Copyrighted properties, and are bundled, associated, watermarked, and embedded within Intellectual Properties. In the preferred embodiment of the Present Invention, there are also Generic TCI's. A TCI in the header of a transmission represents a generic Intellectual Property/Copyright notice which is human readable within the headers of digital transmissions. A generic TCI does not contain the details of the property title, who owns it, how much it costs, which account must be credited for when the property is transfered. This type of property specific information in the interest of digital commerce is what constitutes a property specific TCI, which is to be embedded, watermarked, bundled, and associated with specific Intellectual and Copyrighted Properties by the Intellectual Property Archive (IPA). Both forms of TCI information are provided as a unique indication to responsible third parties, including: Internet Providers (IP's), Network Provider's (NP's), Connectivity Provider's (CP's), (such as phone, cel, cable, wireless, or satellite), Digital Content Provider's (DCP's), Servers, or Routers, and individuals; that to effect the lawful transfer of this information from party to party requires a transaction to occur. Therefore, generic TCI's are defined under the present invention as digital protocol flags to responsible third parties, autonomously informing said third parties that special processing must occur for this information to be legally transferred.

Similarly, Property Specific TCI's do more than contain the legal requirements of transfer of Intellectual Properties. Being of a similar, distinguishable format as generic TCI's, Property Specific TCI's may be machine readable as embedded within the content of Intellectual and Copyrighted properties. This distinction exists as precautionary measure against the eventuality of digital pirates removing generic TCI information from transmissions containing Intellectual Properties. Property specific TCI information is machine distinguishable as embedded and watermarked within Intellectual and Copyrighted properties, and human readable upon extraction from said Intellectual and Copyrighted properties. The Present Invention is designed to function within unsecured digital media, including the Internet. It is herein suggested that third parties at their discretion utilize TCI information. Should the generic TCI information be stripped from an Intellectual Property, it would require that a responsible third party, transferring said Intellectual Property through its domain, inspect the transmission in transfer through its domain. In the preferred embodiment of the Present Invention responsible third parties establish a policy that transmissions within the responsible third parties domain, be autonomously inspected for the presence of machine-readable TCI information.

If Generic machine readable TCI information is present within a transmission the responsible third party domain will 1) inspect the content of transmissions within its domain, 2) verify with the IPA that the TCI information matches the Intellectual Property, 3) gate the transmission of Intellectual and Copyrighted Property until the requirement of lawful transfer is met, 4) enable the transfer of Intellectual and Copyrighted Property including TCI information.

If a transmission is found to contain Property Specific machine readable TCI information the responsible third party domain will 1) inspect the content of transmissions within its domain, 2) replace the stripped generic TCI information within the transmission, as determined by consulting the IPA, so as to save processing time for the next domain the transmission will pass through, 3) gate the transmission of Intellectual and Copyrighted Property until the requirement of lawful transfer is met, 4) replace the generic TCI information and present the requirements of transfer as contained within the property specific TCI, as confirmed by verification with IPA, to the intended recipient of the transmission 5) enable the transfer of Intellectual and Copyrighted Property, including TCI information.

If a transmission does not contain any TCI information, the responsible third party domain will 1) sample a portion of the content of the transmission if the transmission is a) formatted in a manner common to Intellectual and Copyrighted Property, b) as a matter of statistical or random sampling, c) as a matter of domain policy to inspect all transmissions, 2) verify the sampled portion of the transmission with content within the IPA, 3) gate the transmission if the sampled portion contains all or part of a Intellectual or Copyrighted Property which requires a transaction to occur for legal transfer of said verified Intellectual or Copyrighted Property 4) replace the content of the transmission with a verified copy of the Intellectual or Copyrighted Property as supplied from the IPA, presenting the requirements of lawful transfer to the intended recipient, or forwarding the transmission to the next domain in the process of delivering the transmission to the intended recipient, 5) gate the Intellectual or Copyrighted Property content within the transmission, and request that the IPA forward a verified copy of the Intellectual or Copyrighted Property to the intended recipient.

As illustrated above, TCI's act as Internet Protocols to responsible third parties who elect to utilize TCI information. The presence of generic or embedded, associated, bundled and watermarked, Property Specific TCI's within a transmission provides autonomous gating, inspection, and verification, from responsible third party domains. In the preferred embodiment of the Present Invention, Generic and Property Specific TCI's also contain addresses of specific third party domains; and nodes of the IPA, whereby Intellectual and Copyrighted Properties will autonomously be provided preferential loose source routing of Intellectual and Copyrighted Properties in the interest of Property Rights Management. Herein, within the preferred embodiment of the Present Invention, preferential routing within the Internet may be autonomously provided Intellectual and Copyrighted Properties, by third party domains and routers within the Internet. As in the above example, responsible third parties may utilize TCI information being transferred within their domains, to place multiple intermediate responsible third party and IPA addresses and loose source routing protocols within the headers of digital transmissions containing Intellectual and Copyrighted Properties, as they are transferred through the domains of said responsible third parties. This preferential routing practice provides an additional layer of protection for the holders of Intellectual and Copyrighted Properties. Intellectual and Copyrighted properties which are distributed directly from the IPA, or a node of the IPA will also contain the addresses of preferential intermediate destinations, and loose source routing protocols or header extensions within transmissions.

TCI's may also be placed within the headers of transmissions of digitized Intellectual and Copyrighted Properties so as to further make Intellectual and Copyrighted Properties in transfer within digital media, recognizable to responsible third parties. Said third parties may include, but not be limited to, Internet Providers (IP's), Network Provider's (NP's), Connectivity Provider's (CP's), such as phone, cel, cable, wireless, or satellite), Digital Content Provider's (DCP's), Servers, Routers, corporations, individuals, and end user devices.

When files are uploaded to the domain of a responsible third party, as an email attachment or FTP transfer, said responsible third party will scan the transmission for third party readable Transaction Code Identifiers. Upon uploading, or in preparation of downloading to an addressee, if a TCI is recognized, the responsible third party will gate the transmission until the requirements of transfer, as contained within the TCI are met by the intended recipient of the said transmission. If the transmission originates from a commercial source, the requirements of the transfer must also be met before commencing downloading. This arrangement places responsible third parties in the position of monitoring data that is being transmitted through their domains, in the interest of Property Rights Management.

IP's, NP's, CP's, DCP's, Server, and Routers, may autonomously inspect transmissions within their respective domains for TCI's and further; may choose to sample content suspected of containing pirated Intellectual and Copyrighted Property, against content contained within the IPA.

In a further embodiment of the present invention, after receiving indication that a properly formatted copy of an Intellectual and Copyrighted Property, is in position to be transferred within a third party IP, NP, CP, DCP, or Servers domain, the IP, NP, CP, DCP, or Server may then gate not only the transmission of the Intellectual and Copyrighted Property but the financial transaction as well; seeing that the conditions of the terms embedded or contained with the Intellectual and Copyrighted Property are met. The IP, NP, CP, DCP, or Server may then receive payment from the customer, further distributing each portion of the payment received to all interested parties; Intellectual and Copyrighted Property owner or distributor. In this embodiment of the present Invention the relationship of the IP, NP, CP, DCP, or Server to the consumer is expanded to include that an account and further compensatory responsibilities exist between the IP, NP, CP, DCP, or Server and the consumer doing business within the domain of the said particular IP, NP, CP, DCP, or Server.

In a further embodiment of the Present Invention, the third party IP, NP, CP, DCP or Server of the above example may elect to collect payment for the transfer, assess a small fee for due diligence, then transfer the remainder of the funds collected to the IPA, to have the IPA further disperse the funds, in accordance with TCI information of record.

It is herein suggested that interested parties, upon successfully being granted patent, or copyright status and protection, may seek to employ a TCI in association with their Intellectual and Copyrighted Property for applications in digital media. A TCI distinguishes digital information as an Intellectual and Copyrighted Property, and therefore unique and bound to restrictions with regard to transfer, ownership, and proliferation.

Further information to be associated with, or embedded within an individual digital Intellectual Property may include: URL code(s), the name of the property holder, the name of the distributor, Trademark Information, the name of the property (song title), the name of the Publisher, descriptive text strings, requirements for purchase or transfer of ownership (or further resources if such transfer may not be accomplished directly over the Internet), product incentive information for further consumer/distributor dissemination, e-mail addresses, further computer information such as a program (applet or Java for example), return form and route for documentation of sale, the name of the Internet Servers and Web Providers involved in the transfer of the file, phone numbers, HTML document(s), the front end of a program such as Gopher, Internet domain name('s), the addresses of Web Servers, file type designations (audio), time/date code, FTP information, product update information, further artist information, artist tour dates and promotional material, pass words, music or property samples, warranty and service information, disclaimers, and accommodations for consumer feedback, in the interest of promoting commerce.

Clearly there currently exists a void with regard to registering Intellectual Property Identifiers and or associated information in a secure and referential manner. Given methods of business wherein multiple copies of Intellectual Property are in effect promoting their own multiplication, distribution, and disbursement, via. peer-to-peer transfers, a referential database of comparative and iconological information associated with Intellectual Property needs to be established.

Accordingly, several objects and advantages of the present invention include:

(a) improved accountability of consumers to owners of Intellectual Properties.

(b) improved monitoring of transactions, which involve Intellectual Properties.

(c) a novel distribution structure, which promotes commerce.

(d) increased dissemination of the requirements of lawful transference of Intellectual Properties to consumers

(e) facilitation of multiple, or tiered distribution schedules of Intellectual Properties.

(f) a method for increasing consumer involvement in the proliferation of legally transferable Intellectual Properties.

(g) a method for expanding the market for individually distributed Intellectual Properties.

(h) novel protocols for Intellectual Properties.

(i) digitized information incarceration via. Intellectual Property Archive IPA publication of {TCI's}

(j) artificial cognizance of domain geography

### BRIEF DESCRIPTION OF THE DRAWINGS

FIG. 1 illustrates responsible third parties inspecting transmissions with varying degrees of diligence, and accessing the Intellectual Property Archive, said Intellectual Property Archive nodaly inspecting third party transmissions, and Internet artificially, and autonomously cognizant of geographical, societal mores and realities.

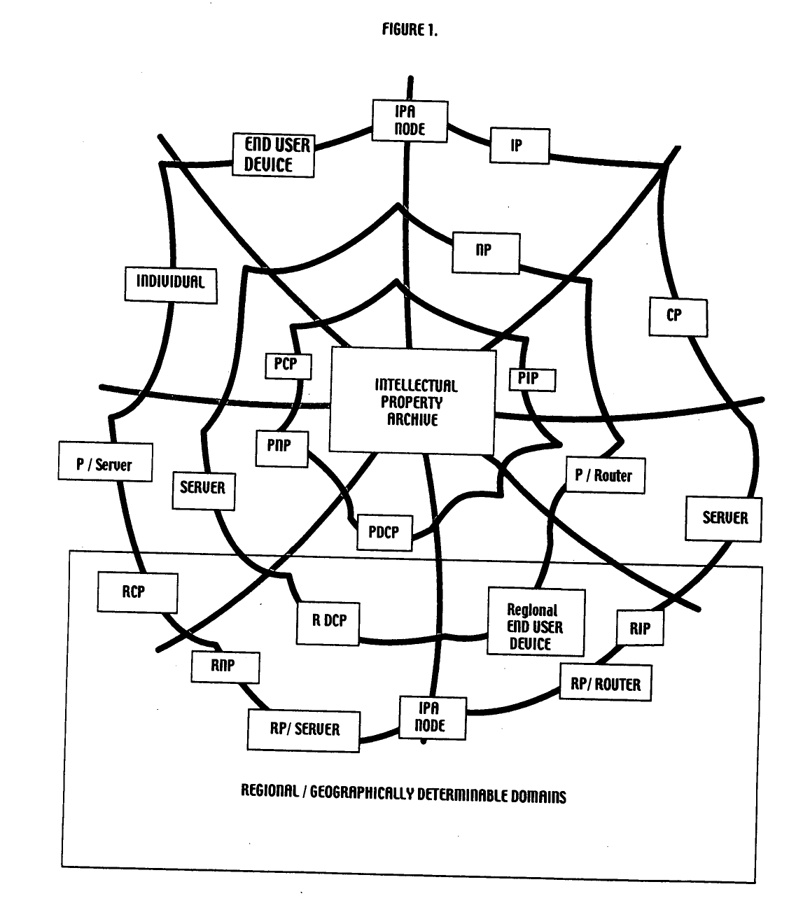

FIG. 2 represents an ICP in transfer, bearing TCI information, II, {TCI} information intermediate third party destination addressees, regional addresses, parental controls, content standards, and regional standards.

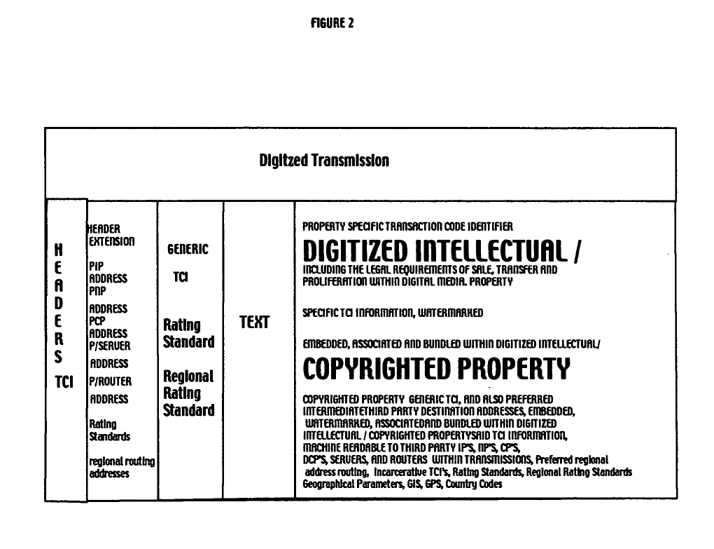

### DETAILED DESCRIPTION OF THE INVENTION

In the preferred embodiment of the present invention, Intellectual and Copyrighted Properties, including Trade Secrets, shall be embedded, prefaced, and associated with preferences for Provider Routing, This shall include digital files not originally intended for Internet applications. By way of example, digital videos, music CD's and software programs which are intended to be sold to end uses, are all capable of being transferred upon the Internet. It is herein suggested that such Intellectual Properties be prefaced, watermarked, and associated with programs (applets, java code, etc.), so that if transferred via the Internet, such Intellectual Properties will be transferred through nodes of domains which have an interest in assuring accountability to Intellectual Property holders.

Such nodes consist of proprietary Intellectual Property Archive, and Third Party networks established in deference to Intellectual Property holders, including IP's, NP's, CP's, DCP's, Servers and Routers who agree to a prescribed level of due diligence with regard to promoting accountability within their respective domains. However, regardless of the nature of the Provider that Intellectual and Copyrighted Properties are preferentially routed to, methods of identifying an Intellectual Property may include Intellectual Property Identifiers (TCI's), scanning of digital files within a Providers domain against reference libraries of Intellectual and Copyrighted Properties including an Intellectual Property Archive; as Intellectual and Copyrighted Properties are unique and identifiable digitized information, or via routing protocols as associated with Intellectual and Copyrighted Properties. Further programs, embedded insignia, watermarks and the like may also serve to distinguish Intellectual Properties, however, upon recognition by responsible third party IP's, NP's, CP's, DCP's, Servers and Routers, the further routing of said Intellectual Property transmission may be gated until said responsible third party IP's, NP's, CP's, DCP's, Servers and Routers are satisfied that the conditions of lawful transference, sale, or proliferation of said Intellectual and Copyrighted Property are met.

It is herein suggested that in the preferred embodiment of the present invention Intellectual Properties will themselves, promote specific paths of transfer of Intellectual Property upon the Internet, and further, that the routes taken by digital bundles will serve to identify said digital bundles as Intellectual Property.

It is herein further suggested that in the preferred embodiment of the present invention, Internet Providers and service organizations which promote accountability to the owners of Intellectual and Copyrighted Property will receive preference with regard to routing of digital traffic by those who are interested in promoting accountability within digital domains.

When files are uploaded to a Third Party Internet Provider (IP), Network Provider (NP), Connectivity Provider (CP), such as phone, cel, cable, wireless, or satellite), Digital Content Provider (DCP), Server, or Router, as email or attachments said IP, NP, CP, DCP, Server, or Router will scan the transmission for Transaction Code Identifiers. Upon uploading, or in preparation of downloading to an addressee, if a transaction code is recognized, the Third Party IP, NP, CP, DCP, Server, or Router will gate the transmission until the requirements of downloading are met by the recipient. This arrangement places said third party IP, NP, CP, DCP, Server, or Router in the position of monitoring data that is being transmitted through their systems. On the receiving and distribution end of peer-to-peer transmissions, end user devices may also be equipped with software, capable of distinguishing TCI's in digital transmissions; said end user software being bundled within the end users operating system, or as an additional downloadable program, whose presence will be recognizable to Third Party IP, NP, CP, DCP, Server, and Routers, before transmissions of TCI's will be performed to said end user devices. IP, NP, CP, DCP, Server, and Router assessment of specific end user programs, provides a non-invasive, additional layer of protection to Intellectual and Copyrighted property holders.

In a further embodiment of the present invention, after receiving indication that a properly formatted copy of an Intellectual or Copyrighted Property (ICP), is in position to be transferred within a Web Service organizations domain, the Web Service organization may then gate not only the transmission of the ICP but the financial transaction as well; seeing that the conditions of the terms embedded or contained with the ICP are met, the Web Service organization may then receive payment from the customer, further distributing each portion of the payment received to all interested parties, ICP owner(s) or distributor. In this embodiment of the present invention the relationship of the Web Service organization to the consumer is expanded to include that an account and further compensatory responsibilities exist between the Web Service organization and the consumer doing business within a particular Web Service organization's Domain.

The preferred embodiment of the Present Invention embraces methods of statistically converting micro payments into macro payments for digital transfers of Intellectual and Copyrighted Properties (ICP's). As such the Present Invention is amenable to multiple accounting practices in the interests of the holders of ICP's, Intellectual Property Archives, third party IP's, NP's, CP's, DCP's. Server, Routers, and economies of scale. Collection and transfer of payment of funds may include micro payments from and to, holders of ICP's, Intellectual Property Archives, third party IP's, NP's, CP's, DCP's. Server, Routers, and collected summations between parties to keep banking and accounting costs down. The Present Invention may provide for example, statistical sampling and averaging of payment of transactions, in the interest of economies of scale. In this manner the Present Invention may increase profitability of micro payments within digital media. In like manner the Present Invention also offers improvements in cash flow and leverage, as will become recognizable to those versed in business economics. Herein the IPA may make statistical samplings of transactions as identified by TCI's/II's, and statistically convert said statistical samplings of transactions from micro payments, to macro payments, in the interest of ICP holders, and in the interests of economies of scale. Within the scope of the Present Invention it may become practical and profitable for banking/credit organizations to pay third parties based upon a statistical sampling of internet traffic, in advance of month end tabulations, wherein accounts may be adjusted upon tallying detailed micro payments in proceeding audits, thus improving cash flows and economies of scale of cash transfers for service organizations, and to be regarded as an advance accruing interest by banking/credit organizations.

The Present Invention will also provide service in areas outside of e-commerce. Third party IP's, NP's, CP's, DCP's, Servers, and Routers, may autonomously inspect transmissions within their respective domains for TCI's and further; may choose to sample content suspected of containing pirated Intellectual and Copyrighted Property, against content contained within the IPA, and preferred Third party PIP's, PNP's, PCP's, PDCP's, and PS's, who exercise the highest level of diligence with regard to Property Rights Management.

The IPA may also contain socially unacceptable material which may be referenced to prevent its proliferation upon the Internet. There exists material which society deems illegal to transfer or possess. Unfortunate examples include child pornography, detailed plans for weapons of mass destruction, and information that could only be useful in terrorist activities. Such digitized information, which has been deemed illegal to transfer or possess, may be contained within the IPA as a reference, that shall not be transferred from the IPA, but only referenced against transmissions within the domains of Third Party IP's, NP's, CP's, Server, and Routers, so that said IP's, NP's, CP's, Server, and Routers may gate the proliferation, and transfer of such material.

Further, the IPA may utilize software, which identifies common characteristics of socially unacceptable material, rather than having to make direct comparison with known subject matter. Should the IPA determine in this manner, that a correlation exists with content in process of transfer, and socially unacceptable material, the IPA may then autonomously request human assessment and intervention by authorities.

The above discussion suggests a TCI for socially unacceptable material ({TCI}); and that both generic and property specific {TCI}'s be imbedded, associated, and watermarked with such material so as to digitally incarcerate the proliferation of socially unacceptable digitized information.

The applicant humbly suggests that a {TCI} may be employed in an adaptive manner in accordance with the development of Internet laws. An obvious example would be in the arena of public domain. If an image is published and largely disseminated, there comes a point where it becomes public domain. Supposing a young individual, out of desperation or deceit, allows a compromising illicit photograph to be distributed upon the Internet. Years later, the individual may decide that it would be harmful to self, or loved ones to perpetuate the distribution of the said image within digital media. Under the Present Invention, the technology would exist to publish a {TCI} within the IPA, effectively terminating the open, legal distribution of the image. This adaptation of the Present Invention would be available, should courts decide that the rights of an individual, on a case-by-case basis, outweigh the benefit to society with regard to particular digitized information. If laws did so evolve, the technology would exist under the Present Invention to support such new laws. Under existing laws, the {TCI} of the present invention allows determinable owners of Intellectual and Copyrighted Properties greater latitudes in Property Rights Management. Information to be restricted in the interest of Property Rights or public domain management is herein described as Incarcerative Information (II).

A further example of the Present Inventions ability to adapt to evolving legal requirements includes regional laws. In the preferred embodiment of the Present Invention, preferred intermediate destination addressing involves the distribution of digitized information through specific IP's, NP's, CP's, DCP's, Servers, and Routers. Specific intermediate destination addressing enables regional, geographical information to be included within TCI's and {TCI}'s so as to make the Internet autonomously cognizant of geographical realities. The present invention intends to extend this applicability beyond country codes, associating greater geographical detail including GIS/GPS information with specific digitized addresses. Herein the Present Invention will embrace Regional IPA Servers, networks and Routers, Regional third party Internet Providers (RIP's), Network Providers (RNP's), Connectivity Providers (RCP's), Digital Content Providers (RDCP's), Servers (RS), Routers (RR's), and further third party Regional Preferred Internet Providers (RPIP's), Network Providers (RPNP's), Connectivity Providers (RPCP's), Digital Content Providers (RPDCP's), Servers (RPS's), and Routers (RPR's), and regional verified end user devices, within the scope of the present invention.

An example would be a legitimate movie production facility in Hollywood being responsive to regional mores in Saudi Arabia. Here the movie production facility may provide two edits of a single film: one edit, TCI embedded with Internet Protocol information to promote proliferation through specific loose routing preferences, and a second edit embedded with negative routing preferences for loose source regional routing, i.e. regional {TCI}. This embodiment of the Present Invention raises serious issues of the potential of regional totalitarian abuse. However, the applicant has faith that the self-editing of a free society will prove more beneficial as compared to complete regional denial of distribution of digital information. Totalitarian regimes have closed off outside Internet access numerous times in recent history. However getting self edited information into a totalitarian region would be better than none at all, for the movie production facility of the present example, and the target society.

Within a free society, it is herein suggested that TCI information include rating standards so as to work with parental controls with regard to legitimate content. In this embodiment of the Present Invention, TCI information may be made recognizable to end user devices for this intended purpose. It is the applicants desire that aspects, or parts of the body of the present invention be viewed as relative, adaptive, and tolerant in perspective; i.e. {TCI} or TCI may be employed by end user devices to filter films that are rated by motion picture associations to be for mature viewers, and further that Incarcerative Information (II) may be viewed in relative terms as well, for the purpose of best exploiting the distribution of ICP's and II's; as some cultures will draw different lines of departure with regard to ICP's and II's. Within the tolerant intent of the Present Invention, TCI, and {TCI}. will be adaptable to the societal mores, as will best serve the requirements of given societial perspectives.

The preferred embodiment of the present invention consists of a physically dispersed and redundant system of computers, regional IPA Servers, networks and Routers; third party IP's, NP's, CP's, DCP's, Servers, Routers, third party Preferred Internet Providers (PIP's), Network Providers (PNP's), Connectivity Providers (PCP's), Digital Content Providers (PDCP's), Servers (PS's), and Routers (PR's), and end user devices connectable to the Internet, hereafter called the Intellectual Property Archive (IPA). The IPA structurally consists of a tiered peer-to-peer network, of distributed authentication, processing, storage and distribution. In the Preferred Embodiment of the Present Invention there are five tiers, including 1) Centralized oversight, 2) Regional authentication, oversight and administration, 3) Preferred third party gateway PIP, PNP, PCP, PDCP, PS and PR oversight and authentication, 4) third party gateway IP, NP, CP, DCP, Server and Router oversight and authentication, 5) end user peer to peer distribution and end user device oversight and authentication.

Holders of Intellectual Property who decide to employ the present invention are requested to submit copies of their Intellectual Property, proof of identification, and further contractual information to be associated with said Intellectual Property as a requirement of commerce, to a regional Governing Body of the IPA. The IPA's regional Governing Body checks the validity of submitted information. Upon verification of the accuracy of submitted materials, the regional Governing Body will endorse the application of TCI's to be associated with the submitted Intellectual/Copyrighted Property, or {TCI}'s to be associated with information to be legally restricted. The Regional IPA Governing Body searches the IPA for conflicts of information, and confers with Centralized IPA oversight with regards to legitimacy of information. Lacking conflicts of interest or information, generic, and property specific TCI's and {TCI}'s are then associated, watermarked, embedded, and prefaced within the headers and content of individual Intellectual and Copyrighted Property, and restricted information, by the IPA's Regional Governing Body. The Intellectual, Copyrighted, or restricted Property, including TCI's and {TCI}'s are then published within the IPA. The IPA continually updates information regarding content and location of Intellectual, Copyrighted, and restricted Properties, between regional networks, computers, Servers, and Routers. The Regional tier of the IPA places information in appropriate locations for the purpose of regional access of often requested information. For the purposes of networking and distribution, the IPA may distribute commonly requested, or high demand digital information within multiple Regional IPA systems for reasons of scalability. Regional IPA systems represent one level of information, network and Property Rights Management.

In the Preferred Embodiment of the Present Invention the IPA employs a tiered peer-to-peer backup system embracing a global peer-to-peer Web cache at multiple levels, including the end user level; an Overlay network of regional IPA networks computers, Servers, and Routers; an intermediate level of third party IP's, NP's, CP's, DCP's, Servers, and Routers, and a further level of third party preferred PIP's, PNP's, PCP's, PDCP's, PS's, and PR's,

The Overlay network of regional IPA Networks, Computers, Servers, and Routers provides administrative oversight and authentication under the Present Invention. By charter, all regional IPA Computers, Servers, and Routers are ultimately responsive to centralized oversight; corporate, governmental, and legal, so as to avoid conflicts of interest. The Centralized Overlay network of regional IPA computers, Servers, and Routers also assists with regional distribution in support of networking and scaling issues. At the Regional level (i.e. top domain level) submissions for TCI's and {TCI}'s are introduced by regional and governmental jurisdictions. Each country or Regional Division provides due diligence in issuing specific generic and property specific TCI's and {TCI}'s. Country/Regional offices then access the centralized IPA overlay network to determine that there are no Country/Regional conflicts.

IPA overlay networks force the Internet to route packets differently by moving them between specific computers servers and routers, should regional differentiation be mandated by governmental and societal demands.

Third party IP's, NP's, CP's, DCP's, Servers, and Routers represent a tier of oversight within the Present Invention. This tier provides additional information management and Property Rights Management under the preferred embodiment of the Present Invention. Third party IP's, NP's, CP's, DCP's, Servers, and Routers inspect transmissions within their respective domains for the presence of TCI's and {TCI}'s, within the headers, and content of said transmissions. The Third party IP's, NP's, CP's, DCP's, Servers, and Routers gate, inspect, verify and consummate the legal requirements of sale, proliferation and transfer of Intellectual, Copyrighted, and restricted Properties within their respective domains. Said Third party IP's, NP's, CP's, DCP's, Servers, and Routers may also inspect the content of transmissions within their respective domains to determine that said transmissions contain Intellectual, Copyrighted, and restricted Properties which have been stripped of TCI's and {TCI}'s, by comparing content contained within said transmissions against content within the IPA. Inspection by Third party IP's, NP's, CP's, DCP's, Servers, and Routers against content that has been stripped of TCI's and {TCI}'s may be performed autonomously as a matter of course, or may be employed for content with a high probability of containing Intellectual, Copyrighted, and restricted Properties. Format of information may provide an indication that content has a reasonable expectation of containing Intellectual, Copyrighted, and restricted Properties, for example MPEG, JPEG, or AVI formatted information will generally contain copyrighted material.

Therefore Third party IP's, NP's, CP's, DCP's, Servers, and Routers may autonomously access the IPA when certain formats are found within transmissions within their respective domains. If transmissions within the respective domains of Third party IP's, NP's, CP's, DCP's, Servers, and Routers are found to contain Intellectual, Copyrighted, and restricted Properties, said Third party IP's, NP's, CP's, DCP's, Servers, and Routers may gate the transmission, and forward information contained within TCI's as obtained from the IPA, to the intended recipient. Certain Third party IP's, NP's, CP's, DCP's, Servers, and Routers may choose as a matter of policy to gate the transmission, and enable the IPA to become active with regard to the transmission; forwarding TCI information to the intended recipient, or forwarding the Intellectual and Copyrighted Property with TCI information embedded, watermarked, and associated information to the intended recipient.

A further tier within the Present Invention is represented by Third party Preferred PIP's, PNP's, PCP's, PDCP's, PS's, and PR's. As described earlier, this tier assumes greater diligence on behalf of ICP holders, and in a variation of the Present Invention, may therefore be addressed by Third party IP's, NP's, CP's, DCP's, Servers, and Routers, and end user devices as distributors of ICP's, and may confirm TCI's in the interest of scalability and efficiency.

The Present Invention is adaptive in the application of peer-to-peer distribution. It is foreseeable within the scope of the Present Invention that Third party IP's, NP's, CP's, DCP's, Servers, and Routers as responsible parties, acting towards their own best interest, and in the interest of third party Property holders, will also form overlay networks, in the form of alliances between organizations in the interest of information management and scalability. Herein third parties at the intermediate Third party IP, NP, CP, DCP and Server tier may multiplex information and cooperate with the intent of scaling and storing TCI embedded, associated, and watermarked Property efficiently, as would be mutually beneficial, forming a cost effective alliance. The applicant respectfully submits that when responsible parties are involved in peer-to-peer distribution, there comes an economy of scale in processing, storage, scalability, and distribution of Intellectual and Copyrighted Properties. As in the above example said Third party IP's, NP's, CP's, DCP's, and Servers may multiplex information and cooperate with preferred Third party PIP, NP, CP, DCP and Servers, as well as the IPA overlay network.

A further tier of the Present Inventions structure, as described within the preferred embodiment includes end user devices and traditional peer-to-peer distribution. The Present Invention is novel with regard to prior peer to peer distribution in that end users may lawfully distribute Intellectual and Copyrighted Properties directly to and from end user devices, to and from Third party IP's, NP's, CP's, DCP's, Servers, and Routers, preferred Third party PIP, PNP, PCP, PDCP and PS, as well as the IPA overlay network and also directly to (in the instance of a submission) and from the IPA. Though the architecture is tiered in the Preferred Embodiment of the Present Invention, barriers are removed from accessing each tier under the present Invention. The IPA and Third party PIP's, PNP's, PCP's, PDCP's, PS's, and PR's effectively create nodes of responsible Property Rights Management, through which traffic upon the Internet is verified in the interest of Property holders.

In the preferred embodiment of the Present Invention, the IPA consists of a physically dispersed and redundant system of computers, networks, including an IPA overlay network, IP's, NP's, CP's, DCP's, Servers, Routers, preferred Third party PIP's, NP's, CP's, DCP's and PS's, PR's, and end user devices, wherein a degree of separation from the Internet and connectivity providers is acceptable. By way of example, cel phones and wireless computer networks enable end user devices to function in conjunction, and separate from the Internet. A cel phone or PDA is certainly connectable to the Internet, via. a Connectivity Provider. DVD players, CD burners, and VCR's are not commonly considered computers, or Internet devices, but digital information is migratable to and from them to the Internet. There are multiple end user devices which are migratable on and off larger networks, The Present Invention intends to specifically embrace migratable devices, by placing TCI recognition and gating software upon intermediate and migratable end user devices.

In a variation of the Present Invention end user devices will contain software in consort with Property Rights Management technology of the Present Invention. This software will reside upon end user devices which are connectable to the Internet and Connectivity Providers; such as computers, PDAs, and Cel phones, by way of example. The benefit of placing additional Property Rights Management protection upon end user devices extends the Present Invention to end user devices, which are once step removed from the Internet, and connectivity providers. Examples of end user devices which are one step removed from the Internet, and connectivity providers include game cubes, CD players, storage media, DVD players, video recorders, which are capable of providing and receiving digital information once bridged to the Internet, and Connectivity Providers via. end user computational equipped devices. Placing Property Rights Management software upon end user computational equipped devices, provides an additional layer of Property Rights Management protection. In this embodiment of the Present Invention, the IPA and Third party IP's, NP's, CP's, DCP's, Servers, and Routers, and Third party PIP's, NP's, CP's, DCP's and PS's, PR's, determine that the recipients of transmissions from their respective domains, have software on the transmission recipients end user device, which recognizes TCI and {TCI} encoding, before releasing transmissions to end user devices.

Peer-to-peer technology is about increasing the reliability and the redundancy, and scalability of Internet-based systems. The Present Invention disperses Property Rights Management, Information Assessment, Storage and Retrieval, across digital media, Internet and Connectivity Providers, employing a tiered peer to peer architecture; wherein peer to peer distribution may occur across tiers, while maintaining accountability to Property holders and regional social mores. Prior art Property Rights Management architecture required the need for a centralized or monopolistic “Root” to promote security, reliability, and stability. The dispersed, nodal, tiered architecture of the Present Invention provides greater flexibility in information management than prior art models. With the creation of {TCI}'s, greater accountability of information within the public domain is assured. The Present Invention provides the technology to distribute and incarcerate information within digital media, by publication within the IPA. Clearly the Present Invention is an extremely powerful and novel tool for Information, and Property Rights Management.

Third party IP's, NP's, CP's, DCP's, Servers, Routers, and PIP's, NP's, CP's, DCP's, PS's, PR's, and the IPA overlay network, may also inspect the content of transmissions within their respective domains to determine if said transmissions contain Intellectual and Copyrighted Properties which have been stripped of TCI's, by comparing content contained within said transmissions against content within the IPA. Inspection by Third party IP's, NP's, CP's, DCP's, Servers, Routers, and PIP's, NP's, CP's, DCP's, PS's, PR's, and the IPA overlay network, against content that has been stripped of TCI's may be performed autonomously; as a matter of course, or may be employed for content with a high probability of containing Intellectual Copyrighted Properties and restricted Properties. Therefore Third party IP's, NP's, CP's, DCP's, Servers, Routers, and PIP's, NP's, CP's, DCP's, PS's, PR's, and the IPA overlay network may autonomously access the IPA when certain formats are found within transmissions within their respective domains. ICP's (Intellectual and Copyrighted Property's) may be made recognizable to programs designed to identify ICP's against registered ICP's within the IPA.

Every Intellectual and Copyrighted Property is unique and is in itself a signature which is addressable within the domains of commerce, real and virtual, and may be recognizable both part and whole. If transmissions within the respective domains of Third party IP's, NP's, CP's, DCP's, Servers, Routers, and PIP's, NP's, CP's, DCP's, PS's, PR's, are found to contain Intellectual, Copyrighted, and Incarcerative Properties, said Third party IP's, NP's, CP's, DCP's, Servers, Routers, and PIP's, NP's, CP's, DCP's, PS's, PR's, may gate the transmission, and forward information contained within TCI's as obtained from the IPA, to the intended recipient. Certain third party IP's, NP's, CP's, DCP's, Servers, Routers and PIP's, NP's, CP's, DCP's, PS's, PR's may choose as a matter of policy to gate the transmission, and enable the IPA to become active with regard to the transmission; forwarding TCI information to the intended recipient, or forwarding the Intellectual and Copyrighted Property with TCI information embedded, watermarked, and associated information to the intended recipient.

It is apparent from the above delineations that responsible third parties may elect to incorporate several levels of due diligence in the interest of Property Rights Management. 1) Responsible third parties may insure that within their domains generic TCI's are scanned for, and said generic TCI's initiate protocols for special processing for Intellectual and Copyrighted Properties associated with said generic TCI's, gating transmissions and insuring that the legal requirements of sale and transfer have been fulfilled. 2) Responsible third parties may further inspect transmissions within their respective domains for Property Specific TCI's embedded and watermarked within the content of transmissions. 3) The above third parties may then further confirm that the property specific TCI information matches the associated Intellectual Property of the transmission as compared with the Intellectual Property of record within the IPA. 4) Responsible third parties may sample content of transmissions with no apparent TCI information, comparing the sample of transmission content, with content within the IPA: wherein content is itself unique, and distinguishable as Intellectual and Copyrighted Property, as compared with the content of record within the IPA.

In a further embodiment of the Present Invention the IPA consists of a dispersed network, providing international nodal access to content from consumers and distributors, and further, direct nodal inspection of traffic upon the Internet. Herein it is suggested that within this variation of the Present Invention, the IPA may actively inspect and gate transfers of digitized information, transmitted through nodes of the IPA's domain, as an aspect of the Internet framework. As stated earlier Intellectual and Copyrighted Properties may include multiple IPA addresses embedded and associated with said Intellectual and Copyrighted Property to be utilized as addresses for preferential loose source routing, on a global level.

The preferred embodiment of the Present Invention enables lawful distribution of Intellectual Properties from all interested parties: peers, end users, content distributors, content providers, third party IP's, NP's, CP's, DCP's, Servers, and Routers, and the IPA. As the Internet develops, third party IP's, NP's, CP's, DCP's, Servers, and Routers may elect to cache, as well as transfer and verify Intellectual Properties to assist with scalability and demand. In the above example, the described levels of due diligence will obviously be remunerated accordingly. Compensation for assistance with distribution will include increased traffic to particular domains via. loose source routing and compensation for the level of diligence performed. The above examples of Intellectual and Copyrighted properties being embedded, watermarked, bundled and associated with specific addresses of intermediate destination third parties, for preferential loose source routing in the interest of Property Rights Management, also suggests that there will be established by due diligence, third party preferred: Internet Providers (PIP's), Network Providers (PNP's), Connectivity Providers (PCP's), Digital Content Providers (PDCP's), Servers (PS's), and Routers (PR's). In the preferred embodiment of the Present Invention, responsible third parties will act in their own best interest in providing Property Rights Management in the interest of property holders.

The Present Invention is intended to be adaptive in its ability to provide dispersed and autonomous distribution and authority. In a variation of the Present Invention parts of the above described body of oversight levels, including, third party IP's, NP's, CP's, DCP's, Servers, and Routers, third party PIP's, PNP's, PCP's, PDCP's, PS's, and PR's, IPA overlay networks, and the IPA itself may be removed, and the Present Invention may still be deemed viable due dispersion and redundancy. In most instances for example DCP's and PDCP's may do the work of the IPA, as clearly Preferred responsible Third Parties are intended to function with multiple levels of diligence.

Many variations of the processes described in the present application are possible without straying from the spirit and benefits, which may be associated with the present invention. The present invention will also give rise to novel techniques and protocols not delineated herein, which shall also be embraced within the scope of the present invention.

In the claims:

1-11 (canceled)

12-27 (withdrawn)

28). (new) An Intellectual Property Archive (IPA), comprised of a tiered, peer-to-peer network, of distributed authentication, processing, storage and dissemination which serves to promote commerce and acts to verify the validity of contractual agreements within digital medias, wherein
said IPA houses, associates, watermarks, embeds, bundles, inspects, halts, validates and transfers, Transaction Code Identifiers (TCI's), incarcerative Transaction Code Identifiers ({TCI's}), Intellectual and Copyrighted Properties, and Incarcerative Information (II): which is restricted from distribution within public domain, and digital media.

29). (new) An Intellectual Property Archive (IPA) in accordance with claim 28, wherein,
said TCI's are comprised of Intellectual and Copyrighted Property Identifiers which establish Intellectual Properties as unique and bound to restriction with regard to sale transfer and proliferation within digital medias,
said TCI's further being comprised of generic, generic incarcerative ({TCI's}), Property Specific (TCI), and Property Specific incarcerative ({TCI's}) digitized information, machine and human readable within the scope of the Present Invention, and further,
said digital Intellectual Property Archive containing TCI information associated with individual Intellectual Properties in the interest of promoting commerce, and {TCI} information, in the interest of restricting the distribution of individual digitized Intellectual and Copyrighted Properties, and digitized Incaccerative Information within digital medias, and further,
said generic, generic incarcerative, Property Specific, and Property Specific incarcerative TCI's, contain specific addresses of preferred intermediate destinations, for the purpose of loose source routing of said Intellectual and Copyrighted Properties, and incarcerative information to be restricted within digital medias, and further,
said TCI's, Intellectual and Copyrighted Properties, and incarcerative information within digital transmissions, are embedded, associated, watermarked, and bundled with specific, and regional addresses, for the purpose of loose source routing of said TCI's, Intellectual and Copyrighted Properties, and incarcerative information, in the interest of regional societal demands,
said Intellectual Property Archive further serving to verify TCI's, Intellectual and Copyrighted Properties, {TCI's}, and Incaccerative Information, and further,
said IPA validates the requirements of contractual agreements employed in commerce within and without of digital domains.

30). (new) An Intellectual Property Archive (IPA) in accordance with claim 29, wherein,
said TCI's are further comprised of content information, including content rating systems wherein,
means for rating content in accordance with regional and global standards,
means for including rating standards within TCI information,
means wherein said TCI content rating standards are readable to IPA and third party Internet Providers (IP's), Network Providers (NP's), Connectivity Providers (CP's), Digital Content Providers (DCP's), Servers, Routers, third party preferred: Internet Providers (PIP's), Network Providers (PNP's), Connectivity Providers (PCP's), Digital Content Providers (PDCP's), Servers (PS's), and Routers (PR's), end user devices, and IPA overlay network, wherein,
said IPA and third party Internet Providers (IP's), Network Providers (NP's), Connectivity Providers (CP's), Digital Content Providers (DCP's), Servers, Routers, third party preferred: Internet Providers (PIP's), Network Providers (PNP's), Connectivity Providers (PCP's), Digital Content Providers (PDCP's), Servers (PS's), and Routers (PR's), end user devices, and IPA overlay network, gate, and inspect transmissions within above said parties respective domains for said TCI information, including said rating standards, and further,
means of presenting rating standards upon end user devices, and also
means of placing rating standards upon end user devices which are compliant with TCI Property Rights Management, and further,
means whereby, IPA and third party Internet Providers (IP's), Network Providers (NP's), Connectivity Providers (CP's), Digital Content Providers (DCP's), Servers, Routers, third party preferred: Internet Providers (PIP's), Network Providers (PNP's), Connectivity Providers (PCP's), Digital Content Providers (PDCP's), Servers (PS's), and Routers (PR's), and IPA overlay network, determine said placed rating standards upon end user devices, and also,
means wherein, IPA and third party Internet Providers (IP's), Network Providers (NP's), Connectivity Providers (CP's), Digital Content Providers (DCP's), Servers, Routers, third party preferred: Internet Providers (PIP's), Network Providers (PNP's), Connectivity Providers (PCP's), Digital Content Providers (PDCP's), Servers (PS's), and Routers (PR's), and IPA overlay network, gates transmissions to end user devices employing rating standard restrictions as determined in consort with said TCI information, and said rating standard restrictions as placed upon end user devices, and
means wherein, IPA and third party Internet Providers (IP's), Network Providers (NP's), Connectivity Providers (CP's), Digital Content Providers (DCP's), Servers, Routers, third party preferred: Internet Providers (PIP's), Network Providers (PNP's), Connectivity Providers (PCP's), Digital Content Providers (PDCP's), Servers (PS's), and Routers (PR's), and IPA overlay network, consummates transmissions to end user devices employing rating standard restrictions as determined in consort with said TCI information, and said rating standard restrictions as placed upon end user devices.

31). (new) An Intellectual Property Archive (IPA) in accordance with claim 30, wherein,
said generic, generic incarcerative, Property Specific, and Property Specific incarcerative TCI's, autonomously trigger protocols within the domains of responsible third parties, said responsible third parties including, third party Internet Providers (IP's), Network Providers (NP's), Connectivity Providers (CP's), Digital Content Providers (DCP's), Servers, Routers, third party preferred: Internet Providers (PIP's), Network Providers (PNP's), Connectivity Providers (PCP's), Digital Content Providers (PDCP's), Servers (PS's), and Routers (PR's), end user devices, and an IPA overlay network, wherein,
said protocols include inspecting, halting, validating and transferring of Intellectual and Copyrighted Properties, and inspecting, validating, and halting, incarcerative information to be restricted within digital medias,

32). (new) An Intellectual Property Archive (IPA) in accordance with claim 31, wherein,
upon detecting the presence of TCI information, within transmissions in transfer within said responsible third parties domain, the responsible third party will,
1) inspect the content of transmissions within its domain,
2) verify with the IPA that the TCI information matches the Intellectual Copyrighted Property,
3) verify with the IPA that the {TCI} information matches the Incarcerative Information,
4) gate the transmission of Intellectual and Copyrighted Property until the requirement of lawful transfer is met,
5) enable the transfer of Intellectual and Copyrighted Property including TCI information.
6) gate Incarcerative Information.
7) determine if end user device employs rating standards
8) consummate transfer in accordance with the legal requirements of transfer, and in consort with rating standards in place upon said end user device.

33). (new) An Intellectual Property Archive (IPA) in accordance with claim 32, wherein,
said responsible third party samples content within the respective domain of said responsible third party, and further,
said responsible third party compares said sampled content with content within said IPA, and,
upon detecting the presence of Property Specific, and Property Specific Incarcerative Information, within transmissions in transfer within said responsible third parties domain, the responsible third party will,
1) replace the stripped generic TCI information within the transmission, as determined by consulting the IPA, so as to save processing time for the next domain the transmission will pass through,
2) gate the transmission of Intellectual and Copyrighted Property until the requirement of lawful transfer is met,
3) replace the generic and Property Specific TCI information,
4) replace the generic and Property Specific {TCI} information,
5) present the requirements of transfer as contained within the property specific TCI, as confirmed by verification with IPA, to the intended recipient of the transmission
6) determine if upon leaving the said responsible third parties domain the transmissions in transfer from said responsible third parties domain will be transferred to an end user device,
7) upon determining that said transmission in transfer from said responsible third parties domain will be transferred to a end user device, said responsible third party determines if rating standards restrictions are placed upon end user devices,
8) said responsible third party transfers said transmission, to said end user device in accordance with rating standards restrictions placed upon end user devices,
9) said responsible third party gates said transmission, to said end user device in accordance with rating standards restrictions placed upon end user devices,
10) said responsible third party enables the transfer of Intellectual and Copyrighted Property, including TCI information,
11) said responsible third party gates, and delete information verified to be Incarcerative Information.

34). (new) An Intellectual Property Archive (IPA) in accordance with claim 33, wherein, said responsible third party will,
1) sample a portion of the content of the transmissions within said responsible parties domain if the transmission is a) formatted in a manner common to Intellectual and Copyrighted Property, b) as a matter of statistical or random sampling, c) as a matter of domain policy to inspect all transmissions,
2) verify the sampled portion of the transmission with content within the IPA,
3) gate the transmission if the sampled portion contains all or part of an Intellectual or Copyrighted Property which requires a transaction to occur for legal transfer of said verified Intellectual or Copyrighted Property,
4) replace the content of the transmission with a verified copy of the Intellectual or Copyrighted Property as supplied from the IPA, presenting the requirements of lawful transfer to the intended recipient, or forwarding the transmission to the next domain in the process of delivering the transmission to the intended recipient,
5) gate the Intellectual or Copyrighted Property content within the transmission, and request that the IPA forward a verified copy of the Intellectual or Copyrighted Property to the intended recipient,
6) gate and delete information verified as Incarcerative Information.

35). (new) An Intellectual Property Archive (IPA) in accordance with claim 34, wherein,
said IPA, including said responsible third parties including, third party Internet Providers (IP's), Network Providers (NP's), Connectivity Providers (CP's), Digital Content Providers (DCP's), Servers, Routers, third party preferred: Internet Providers (PIP's), Network Providers (PNP's), Connectivity Providers (PCP's), Digital Content Providers (PDCP's), Servers (PS's), and Routers (PR's), end user devices, and an IPA overlay network, samples transmissions within the IPA's aggregate domain, for the purpose of statistically converting micro payments into macro payments, in the interest of preferred accounting practices, based upon said sampling of transmissions, and in the interest of economies of scale.

36). (new) A Intellectual Property Archive (IPA), comprised of a physically dispersed and redundant system of computers, regional IPA Servers, networks and Routers; Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices connectable to the Internet, hereafter called the Intellectual Property Archive (IPA), wherein,
said IPA acts in the interest of the holders of Intellectual and Copyrighted Properties, authenticating, processing, storing, verifying and distributing contractual agreements within digital medias, wherein,
generic Transaction Code Identifiers (TCI's), generic incarcerative Transaction Code Identifiers ({TCI's}), Property Specific Transaction Code Identifiers (TCI's), and incarcerative Property Specific Transaction Code Identifiers ({TCI's}) are associated, bundled, embedded, watermarked within Intellectual and Copyrighted Properties, and Incarcerative Information (II) to be restricted from digital distribution, whereby,
said IPA provides Property Rights Management in that said IPA instigates protocols upon autonomously detecting TCI's within the domains of said IPA, and further said IPA scans transmissions within the domains of said IPA for Intellectual and Copyrighted Properties, and information to be restricted from public distribution, comparing said information within transfer, against domains of the IPA which exhibit the highest levels of diligence, in the interest of the owners of Intellectual and Copyrighted Properties, and in the interest of public domain management, wherein,
said IPA, gates transmissions containing TCI's, verifies transmission content and TCI information, validates the transmission, or consummates the required transaction, before transferring the transmission, and further
said IPA, gates information associated with {TCI's}, verifies content associated with {TCI's}, and informs said transmission sender and recipient that content associated with said {TCI's} is non transferable within digital media.

37). (new) An Intellectual Property Archive (IPA) in accordance with claim 36, wherein,
said IPA samples content of transmissions within IPA domains against IPA domains which perform the highest levels of diligence, wherein,
said IPA, gates transmissions containing Intellectual and Copyrighted Properties lacking TCI's, verifies transmission content and TCI information, validates the transmission, or consummates, the required transaction, before transferring the transmission, and further
said IPA, gates transmissions containing restricted content, verifies content associated with {TCI's}, and informs said transmission sender and recipient that content associated with said {TCI's} is non transferable within digital media.

38). (new) A system for controlling the distribution and use of Intellectual, Copyrighted Property (ICP), and information restricted from public domain, and distribution within digital media, i.e. Incarcerative Information (II), within in a global digital communication, telecommunication, cable, fiber optic, and satellite network having an infrastructure of Internet Providers (NP's) Network Providers (NP's) Connectivity Providers (CP's) Digital Content Providers (DCP's) Servers, routers, and end user devices, said system containing:
means for rendering ICP's and II, recognizable to third party IP's NP's, CP's, DCP's, Servers, Routers, and end user devices by the use of Transaction Code Identifiers (TCI's) and {TCI's}, wherein said {TCI's} to be associated with II;
means for associating, watermarking, bundling and embedding said TCI into said ICP,
means for associating, watermarking, bundling and embedding said {TCI} into said II,
means for establishing said ICP and II as unique and bound to restrictions with regard to transfer, ownership, proliferation, and electronic commerce;
means for making the TCI and {TCI} human and machine readable within the header(s) and header extensions of digital transmissions, and machine-readable as embedded and associated within said properties, and further;
means for inspecting all transmissions within the respective domains of the said IP's NP's, CP's, DCP's, Servers, Routers, and end user devices for the presence of said TCI's and {TCI's};
means for halting transmissions determined to contain TCI, and {TCI} identifiers.

39). (new) A system according to claim 38, wherein;
means for placing the requirements for the lawful sale, transfer, distribution, and proliferation of individual ICP's and II's, are contained within said TCI's, and {TCI's}, and further,
means for promoting authorized peer-to-peer distribution within digital media by including of bundling, associating, watermarking and embedding said TCI and {TCI} into digital files bearing the requirements to satisfy said restrictions for each individual ICP or II, with regard to transfer, ownership, proliferation and electronic commerce.

40). (new) A system according to claim 39, wherein;
means for electing by said IP's NP's, CP's, DCP's, Servers, Routers, and end user devices to discretely sample transmissions and data bundles within their respective domains against digital libraries of ICP's and II's:
means for gating the downloading or transference of data files which contain all or part of any individual ICP, or II, in accordance with the protection of said ICP, and II.

41). (new) A system according to claim 40, wherein;
means for placing specific addresses within said TCI's and {TCI's} for the purpose of loose source routing of said associated ICP's and II's in the interest of property rights management, and also;
means of placing regional addresses into the headers, and header extensions of digital transmissions containing ICP's and II's in accordance with societal demands and also,
means wherein ICP's and II's, in consort with TCI's/{TCI's} are responsive to regional societal demands, further;
means of placing content ratings into said TCI's and II's, TCI's/{TCI's} and further,
means of placing content rating thresholds upon said end user devices, and further,
means of said IP's NP's, CP's, DCP's, Servers, Routers, and end user devices determining content rating threshold standards as defined upon said end user devices and,
means of transmitting said content by said IP's NP's, CP's, DCP's, Servers, Routers, and end user devices, in accordance with provisional standards as defined by said end user devices, and further
means of transmitting said content by said IP's NP's, CP's, DCP's, Servers, Routers, and end user devices, in accordance with provisional standards for regional societal demands.

42). (new) A system according to claim 41, wherein;
means of sampling transmissions in transfer through the domains of said IP's NP's, CP's, DCP's, Servers, Routers, and end user devices and further,
means of statistical estimation of aggregate periodic successful acts of commerce based upon said sample of transfers,
means of association of said estimated successful acts of commerce, based upon said sample of transfers, with parties consummating said successful acts of commerce,
means of periodic transfer of real property, based upon said statistical estimation of aggregate periodic successful acts of commerce, to said associated IPA, IP's NP's, CP's, DCP's, and ICP holders,
means of detailed and accurate periodic summation of successful acts of commerce to said end users,
means of periodic transfer of real property, based upon said detailed and accurate periodic summation of successful acts of commerce by said end users,
means of periodic adjustment of said statistical estimation of aggregate periodic successful acts of commerce by said IPA, IP's NP's, CP's, DCP's, and ICP holders,

43). (new) A method for controlling the distribution and use of Intellectual and Copyrighted Property (ICP), and information deemed by societies to be restrictive within public domains, and digital medias, i.e. Incarcerative Information (II), within global digital communication, cable, fiber optic and satellite networks, having an infrastructure of physically dispersed and redundant systems of computers, regional Intellectual Property Archive (IPA) Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices, said method comprising:
step for transmitting ICP's and II's within said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices;
step for associating, embedding, watermarking and bundling ICP's, with Transaction Code Identifier's (TCI's); and said II's with a Incarcerative TCI's, ({TCI's}), to identify said ICP's and II's as unique and bound to restrictions;
step for creating TCI's and {TCI's} that are human and machine-readable within the header(s) of digital transmissions, and machine-readable, as watermarked, and embedded, within said properties, wherein;
step for inspecting all ICP's and II's in transfer within the respective domains of said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices, and further;
step for automatically triggering said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices: to gate transmissions containing said TCI's and II's , and, step for presenting the legal requirements of transfer, sale, ownership, proliferation, and electronic commerce to the intended recipient(s) of said ICP, II, in transfer, as determined by either:
a) property specific TCI/II information watermarked, embedded, associated or bundled with said digitized information in transfer,
b) confirming said legal requirements of transfer, sale, ownership, proliferation, and electronic commerce, for said ICP/II in transfer from the respective domains of said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices; by comparing content against digital libraries of registered, and verified ICP's/II's,
step for verifying that the legal requirements of transfer, ownership, proliferation and electronic commerce, for said ICP/II in transfer from the respective domains of said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices have been met,
step for releasing and transmitting, said ICP/II in transfer to the respective global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices, after the legal requirements of transfer, ownership, proliferation and electronic commerce for said ICP/II in transfer for the respective domains of said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices; has been verified and confirmed as satisfying the legal requirements of transfer, ownership, proliferation and electronic commerce, for said TCI/II in transfer from the respective domains of said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices.

44). (new) A method according to claim 43 further comprising;
step for including, bundling, associating, watermarking, or embedding, the said TCI/{TCI} with the digital files bearing the requirements to satisfy said restrictions with regard to transfer, ownership, proliferation and electronic commerce for said unique ICP's or II's, and further,
step for including, bundling, associating, watermarking, or embedding, the said TCI/{TCI} with specific and regional specific addressing information,
step for said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices; placing said specific and regional specific addressing information, within the headers and header extensions of said transmissions as said transmissions,
step for regional IPA Servers, regional networks and Routers; regional third party Internet Providers (IP's), regional Network Providers (NP's), regional Connectivity Providers (CP's), regional Digital Content Providers (DCP's), regional Servers, Routers, regional third party Preferred Internet Providers (PIP's), regional Network Providers (PNP's), regional Connectivity Providers (PCP's), regional Digital Content Providers (PDCP's), regional Servers (PS's), and regional Routers (PR's), assessing said end user devices, with regarded to geographical and regional standards, with regard to transfer, ownership, proliferation and electronic commerce for said unique ICP's or II's,

45). (new) A method according to claim 44 further comprising:
step for gating said transmission or transfer if ICP/II within the global domains of said digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices, until the requirements of individual ICP's/II's as specified by said TCI's/{TCI's} and of further said digital files bundled with said ICP/II are met.

46). (new) A method according to claim 45 further comprising:
means for enabling a novel distribution of said TCI/II's between individual parties;
means for making individual parties accountable to the owner of said ICP, by said global domains of said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices,
means for restricting said II's by said global domains of said digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices,
means for associating, embedding, watermarking, and bundling, said TCI's and {TCI's} into data bundles that include the requirements to satisfy the restrictions for each individual ICP/II with regard to transfer, sale, ownership, proliferation, and electronic commerce.

47). (new) A method according to claim 46 further comprising:
means for permitting the transference of said ICP/II
means for recognizing that the transfer of real property, or legal tender, has occurred in a binding manner to the effect of satisfying the commerce requirements of an individual ICP/II by the said domains of said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices;
means for permitting the transference of said ICP/II by said domains of said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices,
means for fulfilling the transfer of real property or legal tender, in a binding manner t the effect of satisfying the commerce requirements of ICP/II by the said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices, in accordance with information provided within said TCI/{TCI}, and or said associated, bundled, watermarked, or embedded data, as said TCP/II properties are transferred within, or through the domains of said digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices.

48). (new) A method according to claim 47 further comprising:
means for embedding, watermarking, associating and bundling TCI's and {TCI's} with specific addresses, and regional addressing, for the purpose of providing preferred intermediate destination transfers of ICP's and II's, in the interests of relative regional societal norms, and parental/guardian preferences,
means of detection by said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices; of said specific addresses, and regional addressing of said TCI's and {TCI's}, and further,
means of gating the transfer of said ICP's and II's in accordance with of relative regional societal norms, and parental/guardian preferences,
means of fulfilling the transfers of ICP's/II's in accordance with relative regional societal norms, and parental/guardian preferences, and
means of fulfilling the transfers of ICP's/II's in accordance with the legal requirements of ICP's/II's as determined by said TCI's {TCI's} and further,
means of fulfilling the transfers of ICP's/II's in accordance with the legal requirements of ICP's/II's as determined by verification and validation of said ICP's/II's with content as validated with digital libraries of verified TCP's/II's by comparison of TCI/{TCI} information and or sampling of said content of said ICP's/II's by said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices.

49). (new) A method according to claim 48 further comprising:
means of statistical sampling of transactions as identified by TCI's/II's by said global digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices, and,
means of statistical conversion of said statistical samplings of transactions by digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices; from micro payments, to macro payments, in the interest of ICP holders, and digital communication, cable, fiber optic and satellite networks, having an infrastructure of physically dispersed and redundant systems of computers, regional IPA Servers, networks and Routers; third party Internet Providers (IP's), Network Providers (NP's), Connectivity Providers (CP's), Digital Content Providers (DCP's), third party Preferred Internet Providers (PIP's), Network Providers (PNP's), Connectivity Providers (PCP's), Digital Content Providers (PDCP's), ICP holders, and in the interests of economies of scale, in financial transfers, and therein:
means of accounting and finance, based upon statistical estimation, and adjustment of transfer of digitized ICP's and II's, in the interests of end users.

50). (new) A method for controlling the distribution and use of Intellectual and Copyrighted Property (ICP) and socially restricted, or Incaricerative Information (II), within a global digital communication, cable, fiber optic, satellite, and cellular network, having an infrastructure of third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), and end user devices, said method comprising:
step for generating a Transaction Code Identifier (TCI) to be used to distinguish digitized content as an ICP, that is, unique and bound to restrictions with regard to transfer, ownership, proliferation, and electronic commerce;
step for generating an incarcerative Transaction Code Identifier ({TCI}) for information which is regarded as socially restricted, or Incaricerative Information (II),
step for recognizing the said TCI/II by third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices, whereby,
step for inspecting all the digitized transmissions within the domains of said respective third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices, for the presence of TCI's/{TCI's} by the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices, whereupon;
step for gating said transmission(s) that have been determined to contain said TCI's/{TCI's} by the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices, and further;
step for validating that the legal requirements of transfer, sale, ownership, proliferation, and electronic commerce, have been met, by the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices; and
step for transferring said transmission to the originally intended recipient(s) by said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, IPA overlay network, and end user devices, after the legal requirements of transfer, sale, proliferation and electronic commerce have been validated.

51). (new) A method according to claim 50 wherein:
step for associating, embedding, watermarking or bundling, all or part of said digitized information with generic TCI's or generic {TCI's} within ICP's, or II's for security purposes so as to make said ICP's/II's inseparable from said TCI's/{TCI's}; and,
step for recognizing by third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices; of said generic TCI's/{TCI's}, and further,
step for generating said TCI's/{TCI's} to be human readable and machine readable within the header(s), and header extensions of digital transmissions; and machine readable as watermarked, bundled, associated, or embedded within said ICP/II; whereby;
step for providing ICP Property Management Protection, and II, public domain/societal protection, notification to third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices, by the recognition of the said generic TCI's/{TCI's}, as the said TCI/{TCI} information is transferred to and from said originally intended recipient(s).

52). (new) A method according to claim 51 wherein:
the step of presenting the requirements of transfer, sale, proliferation and commerce, as delineated within said property specific TCI's {TCI's} to the originally intended recipient(s) of said transmissions, by the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), IPA overlay network, and Routers (PR's), and end user devices, before the step of transferring said transmissions within said domains of the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices, to the originally intended recipient(s) of said transmissions.

53). (new) A method according to claim 52 wherein:
step of inspecting digitized transmissions within the respective domains of the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices to determine if said transmissions contain ICP's/II's, which have been stripped of generic or property specific TCI/{TCI} information; and further,
step of comparing the content of digitized transmissions within the respective domains, of said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices, against libraries of registered ICP's/II's, by the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices; wherein,
step of the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices:
a) forwarding the requirements of sale, transfer, proliferation, and commerce, as delineated by said libraries of registered ICP's/II's, to the originally intended recipient,
b) accept a responsible third party has met assurance that the requirements of requirements of sale, transfer, proliferation, and commerce, as delineated by said libraries of registered ICP's/II's have been met,
c) consummates the requirements of sale, transfer, proliferation, and commerce, as delineated by said libraries of registered TCI's/{TCI's}, ICP's and II's
d)) consummates the requirements of sale, transfer, proliferation, and commerce, of said TCI's/{TCI's}, as delineated by third party, high diligence Preferred Internet Providers (PIP's), Network Providers (PNP's), Connectivity Providers (PCP's), Digital Content Providers (PDCP's), Servers (PS's), IPA overlay network, and Routers (PR's).

54). (new) A method according to claim 53 wherein:
step of the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices, placing preferred third party embedded, watermarked, bundled, or associated, specific addresses, and or regional addresses from said TCI's/{TCI's} within the headers of transmissions within the respective domains of said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices, in the interest of Property Rights/public domain/social demand management.

55). (new) A method according to claim 54 wherein:
step of the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), IPA overlay network, and end user devices sampling content and transfers within their respective domains, and further,
step of said third parties and IPA overlay network, submitting said samples to said IPA, wherein,
step of IPA independent audit,
step of said IPA makes periodic transfers of real property to said third party Internet Providers (IP's), Network Providers (NP's), Connectivity Providers (CP's), Digital Content Providers (DCP's), third party Preferred Internet Providers (PIP's), Network Providers (PNP's), Connectivity Providers (PCP's), Digital Content Providers (PDCP's), end users, and holders of ICP's/II's, based upon said samples of content and transfers, and
step of IPA receiving periodic transfers of real property from said third party Internet Providers (IP's), Network Providers (NP's), Connectivity Providers (CP's), Digital Content Providers (DCP's), third party Preferred Internet Providers (PIP's), Network Providers (PNP's), Connectivity Providers (PCP's), Digital Content Providers (PDCP's), end users, and holders of ICP's / II's, based upon said samples of content and transfers, and
step of adjusting said transfers of real property to and from said third party Internet Providers (IP's), Network Providers (NP's), Connectivity Providers (CP's), Digital Content Providers (DCP's), third party Preferred Internet Providers (PIP's), Network Providers (PNP's), Connectivity Providers (PCP's), Digital Content Providers (PDCP's), end users, and holders of ICP's/II's, in accordance with verifiable accounting practices.

56). (new) A computer readable medium encoded with programs for implementing the method of;
step for distinguishing digitized content as Intellectual or Copyrighted Property (ICP), and Socially restricted, or Incarcerative Information (II)
step for recognizing the said ICP/II by third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), ), IPA overlay networks, and end user devices, whereby:
step of inspecting all digitized transmissions within the domains of said by third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), ), IPA overlay networks, and end user devices, by the said by third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), ), IPA overlay networks, and end user devices for the presence of a TCI/{TCI} ; whereupon,
step of gating said transmission, determined to contain said TCI/{TCI} by said by third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), ), IPA overlay networks, and end user devices, and further,
step of said by third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), ), IPA overlay networks, and end user devices, either,
a) determine the legal requirements of sale, transfer, proliferation, ownership and commerce by examining property specific information within the TCI/{TCI},
b) determine the legal requirements of sale, transfer, proliferation, ownership and commerce by comparing property specific information within the TCI/{TCI} against libraries of registered ICP's II's,
c) forward the legal requirements of sale, transfer, proliferation, ownership and commerce as determined by a), b), to the originally intended recipient,
d) validate, that the legal requirements of sale, transfer, proliferation, ownership and commerce have been met, before transferring said transmission to the originally intended recipient,
e) receive verification that the legal requirements of sale, transfer, proliferation, ownership and commerce, have been met by a responsible third party, before transferring said transmission to the originally intended recipient,
f) accept payment on behalf of third party ICP holders, to consummate the legal requirements of transfer, ownership, proliferation and commerce, before transferring said transmission to the originally intended recipient(s).

57). (new) A system according to claim 56, further comprising:
means for generating said generic TCI/{TCI} information that is human and machine-readable within the header(s) of digital transmissions, and machine readable as watermarked, or embedded, within said ICP's/II's, and further,
means for associating, embedding or watermarking said generic ICP's/II's, so as to make said TCP's/II's inseparable from said TCI's/{TCI's};
means for making the said generic TCI's/{TCI's} recognizable by said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's),), IPA overlay networks, and end users, and further,
means for making said generic TCI's/{TCI's} being recognizable as presented to end user devices, as said transmissions are transferred to and from originally intended recipient(s).

58). (new) A system according to claim 57, further comprising:
means for generating Property Specific TCI's/{TCI's} that are machine-readable, as watermarked, or embedded within said ICP's/II's, and further;
means for associating, watermarking, embedding, or bundling all or part of said digitized information with generic TCI's/{TCI's} within ICP's/II's for security purposes, so as t make said ICP's/II's inseparable from said TCI's/II's; and
means for recognizing by third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's),), IPA overlay networks, and end user devices; said Property Specific and generic TCI's/{TCI's}.

59). (new) A system according to claim 58, further comprising:
means for gating the transmission of said data files found to be ICP's/II's, by the said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's),), IPA overlay networks, and end user devices,
means for presenting the requirements of sale proliferation, distribution, and transfer, of particular ICP's/II's, to the addressee of said data file as referenced against digital libraries containing the legal requirements of record in regard to electronic commerce associated with individual ICP's, or II's.

60). (new) A system according to claim 59, further comprising:
means for transferring said ICP's, or II's, upon compliance of the said addressee to render compensation in accordance with the requirements of said legal transfer of ownership, sale, or proliferation of an individual ICP/II, by said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's),), IPA overlay networks, and Routers (PR's), and end users.

61). (new) A system according to claim 60, further comprising:
means of determining geographical locations of specific third party said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's),), IPA overlay networks, and end users,
means of correlation, wherein regional content rating standards are associated with the specific geographical locations of said specific third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's),), IPA overlay networks, and end users,
means of detection by said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's),), IPA overlay networks, and end users of said relative, geographical indexed regional rating standards, and
means wherein said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's),), IPA overlay networks, and end users, gate, verify, distribute and transfer transmissions of digitized ICP's, II's, TCI's. {TCI's}, in consort with said detected geographical indexed regional rating standards,
said geographically indexed parties including, but not limited to: Regional IPA Servers, networks and Routers, Regional third party Internet Providers (RIP's), Network Providers (RNP's), Connectivity Providers (RCP's), Digital Content Providers (RDCP's), Servers (RS), Routers (RR's), and further third party Regional Preferred Internet Providers (RPIP's), Network Providers (RPNP's), Connectivity Providers (RPCP's), Digital Content Providers (RPDCP's), Servers (RPS's), and Routers (RPR's), and regional verified end user devices.

62). (new) A system according to claim 61, further comprising:
means for sampling transactions between said third party Internet Providers (IP's), Network Providers (NP's), Connectivity Providers (CP's), Digital Content Providers (DCP's), Servers, Routers, third party Preferred Internet Providers (PIP's), Network Providers (PNP's), Connectivity Providers (PCP's), Digital Content Providers (PDCP's), Servers (PS's), and Routers (PR's), ), IPA overlay networks, and end users,
means for providing statistically accurate estimations of periodic aggregate transactions, based upon said periodic transaction samplings,
means of accounting for said estimated transactions between said parties, and
means for transferring real property between said parties, based upon statistically accurate estimations of aggregate transactions,
means of adjusting estimations and transfers of real property, upon actual compilation of said transactions between said parties, wherein,
said method provides savings, via. economies of scale to said parties.
